(19) United States
(12) Patent Application Publication
(10) Pub. No.: US 2006/0128298 A1
(43) Pub. Date: Jun. 15, 2006

(54) Extractor hood and input module

(76) Inventors: Ralf Grobleben, Bretten (DE); Frank Hondmann, Bretten (DE); Martin Kornberger, Bielefeld (DE); Jochen Krauter, Hildrizhausen (DE); Peter Rohrbach, Konigsbach-Stein (DE)

Correspondence Address: JOHN T. WINBURN, 100 BOSCH BOULEVARD, NEW BERN, NC, 28562, US

(21) Appl. No.: 10/539,937

(22) PCT Filed: Dec. 4, 2003
(86) PCT No.: PCT/EP03/13706

§ 371 Date: Dec. 27, 2005

(30) Foreign Application Priority Data
Dec. 19, 2002 (DE) 10259748.0

(51) Int. Cl. B08B 15/02

(52) U.S. Cl. 454/56

(57) ABSTRACT

An extractor hood including at least two separate receiving areas for receiving at least one section of an input module in a selective and removable manner. Further an input module for an electronically controlled domestic appliance, such as an extractor hood, including at least one switching element. The input module forms a separate unit of the domestic appliance and includes at least one contact device for bringing the input module into contact with at least one of several interfaces provided in the domestic appliance to transmit signals between the input module and the domestic appliance.

The present invention relates to a fume extractor hood, particularly a flat screen hood, as well as to an input module for a fume extractor hood. In conventional fume extractor hoods, an input module, which can comprise input switches of electronic or mechanical nature as well as indicating devices, is usually provided at the front side of the fume extractor hood.

Particularly in the case of flat screen hoods which have a flat withdrawable screen slide, this is usually equipped at the front side with a furniture decoration strip. The apparatus in the inactive state thereby merges unobtrusively and in visually harmonious manner into the line of top cupboards of a built-in kitchen. The input module in these fume extractor hoods is therefore usually mounted at the side or above or below the screen.

Moreover, in German Utility Model G 91 13 763.2 a fume extractor hood is described in which the electrical switching device is integrated in a hollow grip rod.

Since the input module is arranged at a fixed location in the fume extractor hood, it can happen in the case of different users of the fume extractor hood that the input module is difficult to see or operate or the visual sensibilities of the user are disturbed. Change of the user of a fume extractor hood can occur, for example, in the case of built-in kitchens in rented dwellings when the tenant changes.

The object of the present invention is therefore to create a fume extractor hood which can be readily adapted to the requirements of individual users, can be of flexible design and can be produced with low productions costs.

The invention is based on the recognition that the object can be fulfilled in that at least one further position for the input module is provided beyond a first position for the input module.

The object of the present is therefore fulfilled by a fume extractor hood comprising at least two receiving regions for selectable, detachable reception of at least part of an input module.

By selectable reception there is understood in the sense of this invention that the position of the input module can be changed between the at least two receiving regions, i.e. the input module can be selectably positioned at one or the other receiving region. An input module in the sense of this invention comprises at least one switch element, which can have a mechanical or an electrical switch, and can in addition comprise at least one indicating device. The input module is usually used in the form of a switch strip with or without an indicating device. The reception of at least part of the input module can on the one hand ensure a secure retention of the input module, but on the other hand make possible the actuation of the switch elements and viewing of the indicating device.

According to a preferred form of embodiment the at least two receiving regions are represented by cut-outs in at least a part of the housing of the fume extractor hood. Defined fastening regions for the input module are created by provision of cut-outs at the housing. The cut-outs can be provided in the form of depressions at the surface or, however, in the form of, for example, longitudinal grooves. Retention of the input module at different positions can be realised by these cut-outs and recessing of at least a part of the module into the housing can be made possible. The visual appearance can be improved particularly by virtue of the latter advantage.

Preferably at least one interface for the input module is provided at the fume extractor hood, at least one interface is associated with each receiving region and the interface is an interface for current supply and/or for signal transmission. Through provision of such an interface all functions of the input module can be realised at each of the receiving regions and the input module supplied with current. Alternatively, the interface can serve exclusively for signal transmission. In this case the input module can be equipped with an own current supply, for example in the form of a battery. By signal there is understood in the sense of this invention, in particular, the transmission of actuating signals from the input module to control means in the fume extractor hood as well as transmission of status signals from control apparatus of the fume extractor hood to the input module.

Preferably the interface is represented by an electrical contact. However, it is also possible to use as interface a receiver for infrared beams or radio signals. In this case the input module comprises a transmitter which can exchange information with the receiver or can at least pass on information to the receiver. For this purpose, particularly for the exchange of information, the receiver at the fume extractor hood is preferably also designed for transmission of signals and/or radiation and the transmitter of the input module is similarly designed for reception of signals and/or radiation. Actuating data and status data, in particular, are transmitted by way of transmission medium of infrared radiation or radio signals.

The fume extractor hood according to the invention can comprise at least one support plate allowing star-shaped wiring for the at least two receiving regions. In this case the interface can be realised at the at least two receiving regions in the form of electrical contacts and the wiring cost can be kept small.

Preferably the receiving region comprises means for detachable connection with the input module. These means can be realised in the form of the material of the receiving region. If, for example, the control element is designed to be magnetic, then the receiving region of the fume extractor hood is to be designed to be magnetisable. However, other means, such as, for example, means for shape-locking and/or force-locking joint connections, are also usable.

Preferably these means are represented by detent means, screw devices and/or push-in strips. Detent lugs or detent depressions can be provided as detent means. Moreover, it is possible to provide, as screw-connection device in the region of the receiving region, screw domes or simple bores for the passage of a screw. Finally, edges, flanges and other projections, which preferably extend longitudinally, can be used as push-in strips. The input module then has respectively corresponding counter-members for co-operation with the means at the receiving region. Through these means for detachable connection there can be created a stable retention with, at the same time, comparatively simple possibilities of detaching.

Preferably the fume extractor hood comprises at least one panel having at least one cover, which can be detachably received in the at least one receiving region for the input module. For the detachable connection there are preferably used means which are provided at the cut-out for the detachable connection with the input module, particularly detent, screw and push-in devices, wherein the cover has corresponding counter-members for co-operation with the means at the receiving region. As cover, which a part of the panel represents, there is denoted in the sense of this invention a part which in the installed state at least partly covers the cut-out provided for the input module. According to the invention the panel is so designed, or consists of the appropriate number of covers, that the entire cut-out can be covered. Through the provision of at least one panel at least one receiving region in which no input module is received can be covered, which improves the visual appearance of the fume extractor hood and facilitates care, particularly cleaning, of the fume extractor hood. If the panel consists of several covers, then these preferably respectively form separate components which can be individually inserted in the corresponding receiving region.

According to a further form of embodiment at least two covers can be received in each receiving region. Through division of a panel into at least two covers a flexible use of the covers can be made possible. Thus, for example, a part of the panel, i.e. a cover, can be used for the purpose of carrying a trade mark logo or a type designation, whereagainst the other cover can be kept neutral.

With particular preference, the dimensions of at least one cover correspond with the dimensions of the input module. The dimensions of this one cover correspond, at least with respect to width and length, with the dimensions of the input module. With respect to height and thus depth of penetration into the housing of the fume extractor hood the cover can have a smaller extent. Through correspondence of the dimensions of at least width and length it can be made possible to also use the means for detachable connection, which are provided in the receiving region, for the cover. Beyond that, in the case of provision of several covers in a panel, covers which do not correspond with the geometry of the input module also remain in the receiving region in the case of insertion of the input module into this and thus, for example, lead to a fluid transition between input module and housing.

In a particularly preferred form of embodiment three covers are provided for at least one receiving region, wherein the dimensions of one of the covers correspond with the dimensions of the input module. Preferably the middle one of the three covers corresponds with the dimensions of the input module. In this case on the one hand a symmetrical appearance can be created and on the other hand the use of the covers can be simplified.

Preferably the fume extractor hood is represented by a flat screen hood which has at least one withdrawable region and wherein the at least two receiving regions are provided at the withdrawable region. As withdrawable region there is denoted the screen pull-out or drawer in which also at least the front filter can be provided. A part of the withdrawable region can additionally be the grip strip which can, for example, be designed as a furniture decoration strip.

The receiving regions can be provided at the lefthand side, righthand side, upper side and/or front side at this withdrawable region. Through provision of these different positions of the receiving regions the fume extractor hood can be used in variable manner. Thus, for example, the input module can be changed, depending on the respective user, from the righthand to the lefthand side. Account can thereby be taken an ideal manner of right-handedness or left-handedness of different users. In addition, the size of users can be taken into consideration by the variable provision of the control element at the front side or at the upper side. At the upper side the cut-out is preferably provided in an inclined region so as to facilitate viewing of this region.

According to a further aspect the object of the present invention is fulfilled by an input module for an electronically controllable domestic appliance, particularly for a fume extractor hood. The input module comprises at least one switch element and represents a unit separate from the domestic appliance. Moreover, the input module comprises at least one contact device by way of which the input module can be brought into contact with at least one of several interfaces, which are provided at the domestic appliance, for signal transmission between the input module and the domestic appliance.

As domestic appliance there can come into consideration, apart from a fume extractor hood according to the present invention, also, for example, a baking oven or a dishwashing machine. Through design of the input module in a separate unit, which comprises a contact device, the position of the input module can be easily changed, in the case of provision of different receiving regions at the domestic appliance, by removal and insertion into a different receiving region. The input module according to the invention therefore represents a flexible input module.

Preferably the input module comprises at least one contact device by way of which this can be brought into contact with at least one of several interfaces, which are provided at the domestic appliance, for current supply. The contact device for current supply can be identical with the contact device for signal transmission. The advantage of this form of embodiment consists in that an own current supply does not have to be provided in the input module, but the current supply provided for the entire domestic appliance can also be used for the input module.

According to a further aspect of the invention the object underlying the invention is fulfilled by an input module for an electronically controllable domestic appliance, particularly for a fume extractor hood, which comprises at least one switching element, wherein the input module represents a unit separate from the domestic appliance and, physically spaced from the domestic appliance, co-operates with an interface, which is provided for the domestic appliance, for the signal transmission. In the case of this refinement of the input module this can be used at a spacing from the domestic appliance. With a fume extractor hood, for example, the input module can be placed on the worktop and is thus easy for the user to look at and use.

In one form of embodiment the input module has, for co-operation with the interface for signal transmission, a cable connected with the domestic appliance. The advantage of this embodiment consists in that a current supply of the input module can take place from the domestic appliance by way of the cable.

According to a further form of embodiment the input module comprises, for co-operation with the interface for signal transmission, a transmitting device co-operating with a receiving device at the domestic appliance. The transmitting device and receiving device are preferably designed for transmission of infrared radiation and/or radio signals. In this form of embodiment the input module can be moved completely freely in space as long as the range of the transmitting or receiving device is not exceeded.

In this form of embodiment the input module preferably comprises a current supply unit, which can be represented by, for example, a battery.

The features and advantages described with respect to the fume extractor hood are correspondingly relevant and to that extent applicable also to the input module and vice versa.

The invention is described in more detail in the following for a fume extractor hood on the basis of figures which represent non-exclusive examples of the present invention, wherein:

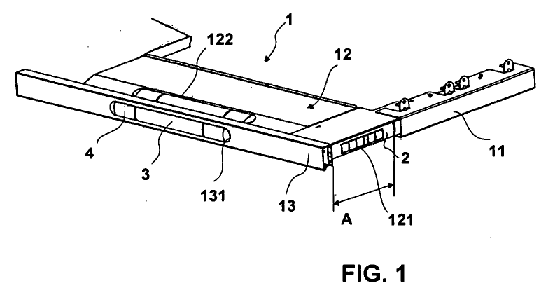

FIG. 1 shows a perspective view of one form of embodiment of a fume extractor hood according to the invention;

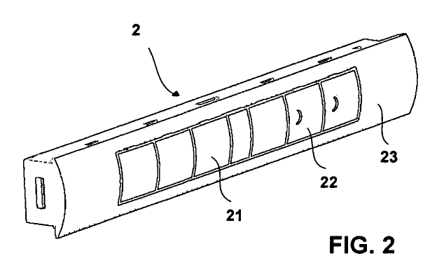

FIG. 2 shows a perspective view of one form of embodiment of an input module accordingly to the invention;

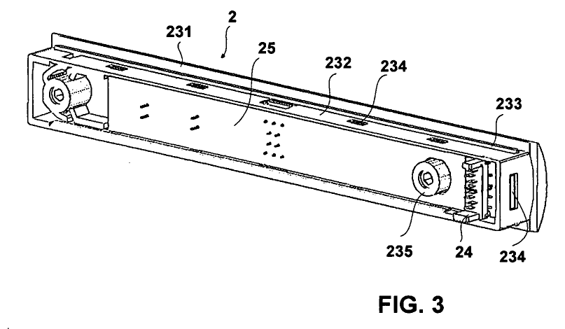

FIG. 3 shows a perspective rear view of the input module of FIG. 2;

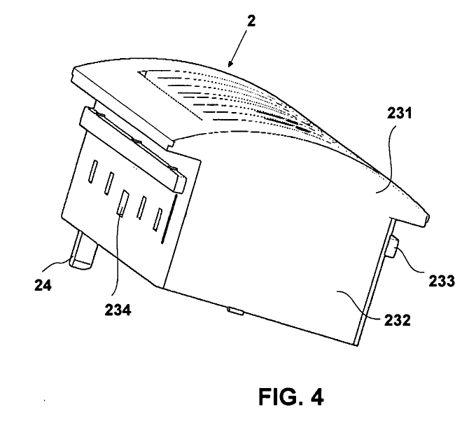

FIG. 4 shows a perspective side view of the input module of FIG. 2;

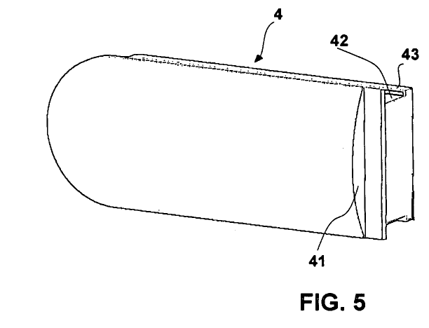

FIG. 5 shows a perspective front view of a short cover;

FIG. 6 shows a perspective rear view of the short cover;

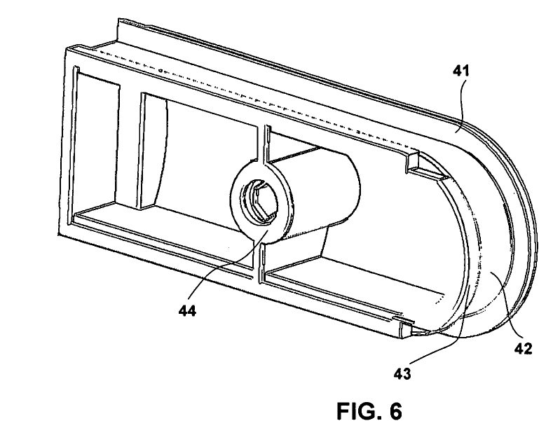

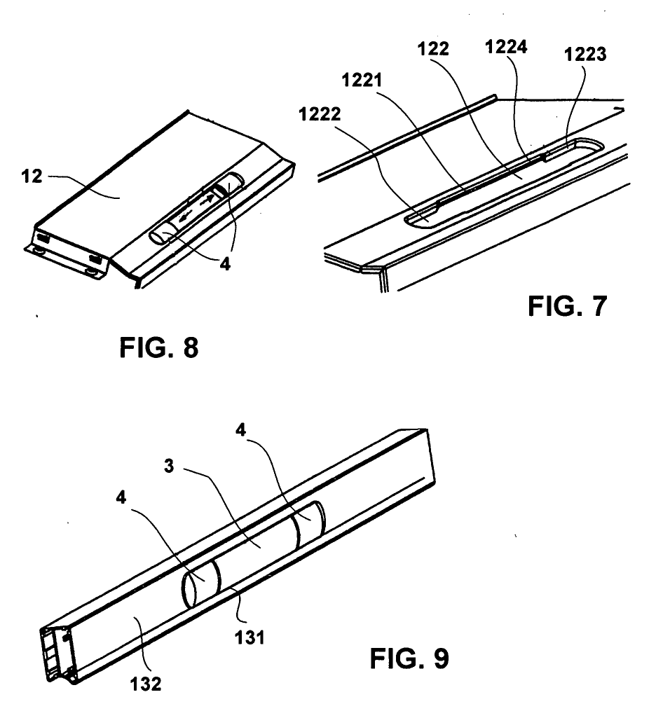

FIG. 7 shows a detail view of the receiving region in the upper side of the drawer of a fume extractor hood according to the invention;

FIG. 8 shows a detail view of the receiving region according to FIG. 7, with two short covers;

FIG. 9 shows a perspective view of a grip strip with two short covers and one long cover;

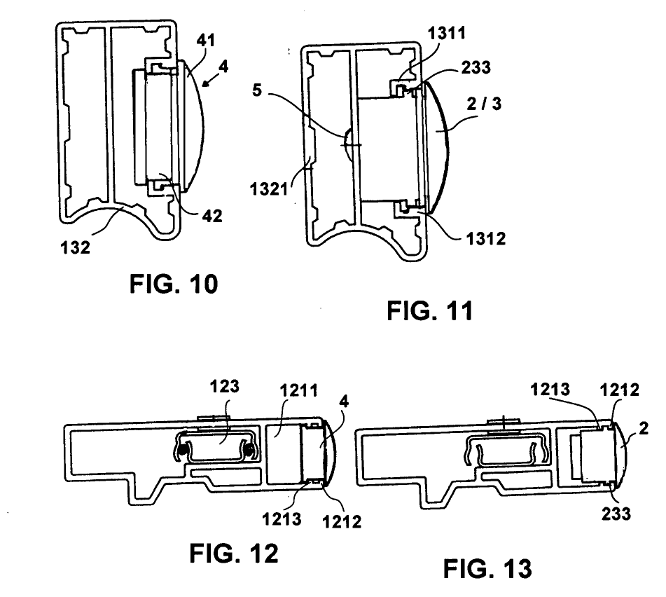

FIG. 10 shows a schematic side view of the grip strip according to FIG. 9, in the region of the short cover;

FIG. 11 shows a schematic side view of the grip strip according to FIG. 9, in the region of the long cover;

FIG. 12 shows a schematic side view of the side region of the drawer with a short cover;

FIG. 13 shows a schematic side view of the side region of the drawer with a long cover;

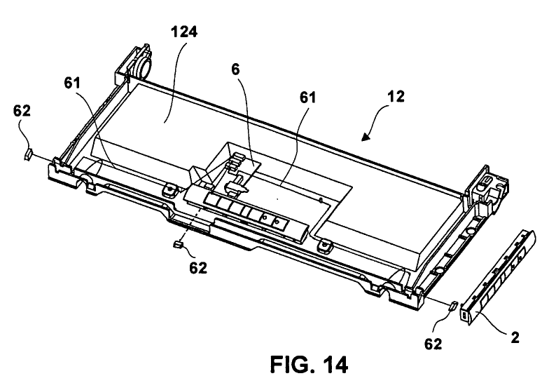

FIG. 14 shows a perspective plan view of a drawer with a schematic representation of the wiring; and

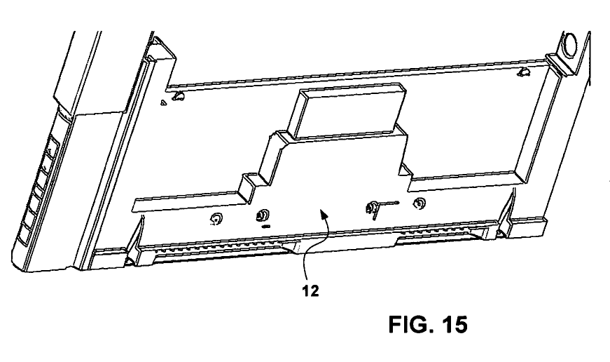

FIG. 15 shows a perspective view, from below, of the drawer.

A part of a fume extractor hood according to the invention is illustrated in FIG. 1. The illustrated part comprises the lateral housing part 11 of the fume extractor hood 1 as well as the forwardly withdrawable region of the fume extractor hood 1, which comprises the drawer 12 and the grip strip 13. The drawer 12 is guided in the lateral housing part 11. In the illustrated form of embodiment an input module 2 is indicated at the side of the drawer 12 over the withdrawal path A. This module is provided in the lateral receiving region 121 of the drawer 12. The further receiving regions 122 and 131, which are provided at the upper side of the drawer 12 and at the front side of the grip strip 13 respectively, are equipped with three covers 3, 4 in the illustrated form of embodiment.

The construction of an input module 2 according to the invention is explained in more detail in the following with reference to FIGS. 2, 3 and 4. As evident from FIGS. 2, 3 and 4, the input module 2 in the illustrated form of embodiment comprises a head part 231 as well as a base part 232 adjoining thereat. The head part 231 has a rounded surface, in which a substantially rectangular opening is provided, through which input knobs 21 or other such switching elements can co-operate with a circuitboard 25. In addition, two indicating devices 22, which can similarly act on the circuitboard, are shown in the rectangular opening in the illustrated form of embodiment. The width of the head part 231 is greater than the width of the base part 232. An offset thereby arises at the transition between the head part 231 and the base part 232. The base part 232 substantially consists of a rectangular boundary wall which is constructed integrally with the head part 231 and in which the circuitboard 25 is received. Longitudinal strips 233 are provided over the length of the base part 232 on the longitudinal sides of the base part 232 respectively in the vicinity of the head part 231. These longitudinal strips 233 extend substantially over the entire length of the longitudinal sides of the base part 232. In addition, openings 234, which can serve for engagement of detent means, can be provided at the longitudinal sides and/or the wide sides of the base part 232.

As further connecting means two screw domes 235 are arranged at the input module at the rear side thereof, i.e. in the region surrounded by the wall of the base part 323. An electrical contact with an interface 62 can, in the illustrated form of embodiment, take place from the input module 2 by way of a contact tongue 24 which extends substantially along the width of the circuitboard 25 and optionally comprises a projection which extends over the height of the input module. The contact tongue 24 is illustrated in, in particular, FIGS. 3 and 4.

In FIGS. 5 and 6 a short cover 4 is shown, which is part of a panel able to cover a receiving region 121, 122, 131 of the fume extractor hood 1. This short cover 4 comprises, in the illustrated form of embodiment, a head part 41 and an outer wall 42. As also in the case of the input module 2, in the case of the short cover 4 the head part 41 is wider than the base part formed by the outer wall 42. An offset thereby arises between the head part 41 and the outer wall 42. The short cover has a flange 43 at the underside of the outer wall 42, i.e. the side which is opposite in the head part 41. This flange protrudes outwardly from the outer wall 42. The illustrated short cover 4 is formed to be right-angled at one side and rounded at the opposite side. In addition, as indicated in FIG. 6 a screw dome can be provided in the region which is surrounded by the outer wall 42.

The selectable introduction of the input module 2 into individual receiving regions 121, 122, 131 of the fume extractor hood 1 will now be described in the following with reference to FIGS. 7 to 13. In FIGS. 7 and 8 the receiving region 122, which is arranged at the upper side of the drawer 12, is illustrated in more detail. As can be inferred from FIG. 7, the receiving region 122 is designed substantially in the form of a longitudinal groove which extends over a centre part of the width of the drawer 12. The receiving region 122 is preferably provided in a region of the drawer 12 which is inclined forwardly. Due to this inclination, the possibility of viewing the input module 2 can be improved on introduction of the input module 2 into this region. The receiving region 122 has substantially three regions over its length. The middle region 1221 has a greater width than the lateral regions 1222. The lateral wall regions 1222 are of semicircular shape at the ends thereof, which represent the ends of the receiving region 122.

Respective projections in the form of collars, which extend into the interior of the drawer 12, are provided in the regions 1221 and 1222. The collars of the parts 1221, 1222 are constructed in different heights. The collar 1224 of the middle region 1221 ends closer to the surface of the drawer 12 than the collars 1223 of the side regions 1222. In particular, the collars 1223 of the side regions 1222 in the illustrated form of embodiment have at the ends thereof flanges extending in the direction of the receiving region 122. By virtue of this displaced collar height, different elements such as, for example, covers 3, 4 for the input module 2 can be introduced in simple manner into the receiving region 122.

The introduction of the short covers 4 can, for example, take place as shown in FIG. 8 in the manner that a short cover 4 is introduced into the middle region 1221 of the receiving region 122 and pushed laterally in the direction of the lateral receiving region 1222. Due to the flange 43 provided at the short cover 4 and the collar 1223, with flange, provided in the lateral receiving region the cover 4 is held in this position by way of the co-operation of the collar 1223 and the flange 43. A second, short cover 4 can also be introduced in like manner at the opposite side of the receiving region 122.

The input module 2 or a long cover 3 can be selectably introduced into the intermediate space formed between these two short covers 4. This can selectably take place by way of screw connections effected in the screw domes 235 provided on the rear side of the input module 2 or by way of corresponding screw domes provided on the rear side of the long cover 3. Alternatively, detent lugs or other detent elements can be provided at the receiving region 122 and engage with the openings 234 at the side of the base part 232 of the input module 2. In like manner a long cover 3, which simply has openings in the outer wall, can be introduced into the receiving region 122, particularly in the intermediate space between the short covers 4.

A grip strip 13 in which two short covers 4 and a long cover 3 or an input module 2 are received is illustrated in FIGS. 9 to 11. The grip strip 13 consists, in the illustrated form of embodiment, of a hollow profile member, wherein a receiving region 131, which substantially has the shape of a longitudinal groove, is provided at the front side of the hollow profile member. The receiving region 131 can have substantially the same form as the receiving region 122 described with reference to FIGS. 7 and 8. In particular, different regions, namely a middle region and two lateral regions with offset collar heights, can be provided in the receiving region 131.

A short cover 4 introduced into the lateral region of the receiving region 131 is shown in cross-section in FIG. 10. As can be inferred from this illustration, the head part 41 co-operates at the part projecting beyond the outer wall 42 with the front side of the profile 132 of the grip strip 13. The flange 43 of the short cover 4 co-operates with the collar 1311 provided at the receiving region 131, particularly with the flange of the collar. A push-in mechanism, which allows simple fastening of the short cover 4, is thereby created.

An input module 2 or a long cover 3 in the receiving region 131 is illustrated in cross-section in FIG. 11. In this case as well, the head part 231 of the input module 2 or the long cover 3 co-operates with the front side of the profile 132 of the grip strip 13. At the rear side the input module 2 or the long cover 3 is connected with the profile 132 of the grip strip 13 by way of a screw 5. This screw 5 co-operates with the screw dome 235 of the input module 2 or a corresponding screw dome of the long cover 3. If the grip strip 13 represents, as illustrated in FIG. 11, a double profile member, then an opening 1321 allowing engagement through by a screwdriver or other tool can be provided in the rear side of the profile 132. The collar 1312 of the middle part of the receiving region 131, which has a smaller collar height than the collar 1311, co-operates with the longitudinal strip 233 at the base part 232 of the input module 2 or the corresponding outer wall of the long cover 3. Retention of the input module 2 or the long cover 3 can thereby be further improved or this can be fixed.

The introduction of an input module 2 or of the covers 3, 4 into the lateral region of the drawer 12 is now described with reference to FIGS. 12 and 13. In the illustrated form of embodiment a drawer telescopic rail 123 is received in a hollow profile member as shown in FIG. 12, which depicts the lateral region of the drawer. The receiving region 121 is provided at the side wall in the lateral profile 1211 arranged laterally adjacent to the hollow profile member. Since access from the rear side of the lateral profile 1211 to the receiving region 121 is not possible due to the drawer telescopic rail 123, the input module 2 and the covers 3 and 4 are preferably connected with the drawer 12 in this position by pushing in. For this purpose an upper and a lower collar 1212, 1213 are provided at the lateral profile 1211 in the region of the receiving region 121. The upper collar 1212 is disposed at the lateral surface of the lateral profile 1211, whereagainst the lower collar 1213 is arranged offset relative thereto in the direction of the interior of the drawer 12. An intermediate space having the form of a longitudinal groove is formed between the upper and the lower collar 1212 and 1213. The width of this longitudinal groove preferably corresponds with the width of the longitudinal strips 233 provided at the base part 232 of the input module 2. In addition, the spacing between the lateral surface of the upper collar 1212 and the lower end of the collar 1213 is so dimensioned that this corresponds with the spacing between the underside of the head part 41 of the short cover 4 and the upper side of the flange 43.

As shown in FIG. 12, a short cover 4 can thus be pushed from the front into the lateral profile 1211 of the drawer 12. Subsequently thereto an input module can similarly be pushed from the front into the lateral profile 1211. In this connection the longitudinal strips 233 of the input module co-operate with the longitudinal groove formed between the two collars 1212 and 1213 and serve as mount and guide of the input module 2 or the long cover. This form of the lateral profile 1211 of the drawer 12 represents an economic variant, since by virtue of the continuously unchanging cross-section this can be produced by extrusion. Access to the front side of the lateral profile 1211 of the drawer 12 can be created by removal of the grip strip 13.

After the different positions of the input module 2 or the covers 3, 4 and the various possibilities of fastening have been described, one possibility of wiring the various receiving regions in the drawer will now be described with reference to FIG. 14. A perspective plan view of a drawer is shown in FIG. 14, wherein the lateral housing parts 11 of the fume extractor hood 1 as well as an upper cover of the drawer 12 have not been illustrated for reasons of easy capability of recognition of the elements disposed thereunder.

A cable cover 124, below which different cables for current supply and actuation of individual functions of the fume extractor hood can be guided, is arranged at the upper side of the drawer 12. In addition, arranged in the middle region of the drawer in the illustrated form of embodiment is an auxiliary plate 6 on which contacts, with which lines 61 are connected, are provided. Three contacts are arranged on the auxiliary plate 6 in the illustrated form of embodiment. A respective contact 62 is provided at the end of the lines 61. These contacts are arranged at the positions representing receiving regions 121, 122, 131. The contact tongue 24 of the input module 2 can come into contact with the current supply and the signal processing of the fume extractor hood by way of these contacts 62 and thus the functionality of the different functions of the input module can be guaranteed. The provision of an auxiliary plate 6 by way of which lines 61 can be connected with the contacts 62 allows a star-shaped wiring. This means, in particular, that it is merely necessary to lay, from control apparatus associated with individual functions of the fume extractor hood, one line each time in the fume extractor hood 1, preferably under the cable cover 124. These lines can be connected with the auxiliary plate 6. Separate lines 61 for the contacts 62, which are in individual receiving regions 121, 122, 131, therefore have to be provided only from the auxiliary plate 6. A saving of lines is therefore achieved by this form of wiring.

Although two input modules 2 are indicated in FIG. 14 at the upper side of the drawer and the righthand side of the drawer, in the case of the fume extractor hood according to the invention preferably exclusively one input module is used. The receiving regions in which no input module is provided are covered by covers 3 and/or 4 so that direct touching of the contacts 62 by the user cannot take place.

A perspective view of the drawer 12 from below is illustrated in FIG. 15. In this connection it can be recognised, in particular, that for fastening of the input module 2 to the upper side of the drawer 12, screw-holes are provided in the drawer housing so that screw-connection of the input module 2 from below the drawer 12 can be carried out.

The present invention is not restricted to the illustrated and above-described forms of embodiment. Thus, the receiving regions can be executed in various forms. These can have rectangular openings, square openings, round openings or openings in the form of a longitudinal groove with or without rounded sides. Preferably the receiving regions at least at the upper side of the drawer and the front side of the grip strip are of the same shape. Although the receiving regions are illustrated in the figures at the upper side and the front side respectively in the middle of the width of the drawer it is possible to provide these at different positions. Thus, for example, a respective receiving region can be provided at the front side of the grip strip on the left and the right. The same applies to the upper side of the drawer. The receiving regions are preferably provided at the sides of the drawer not only at the righthand side, but also the lefthand side. The size of the receiving region of the sides of the drawer preferably corresponds with the withdrawal travel of the drawer, i.e. the spacing between the front edge of the lateral housing part of the fume extractor hood and the rear side of the grip strip.

The size of the receiving regions, particularly of the cut-outs, can be designed so that these can receive merely one input module or one long cover 3. However, it is also possible to design the size of the receiving regions so that in addition to an input module one or two covers can be received.

The shape of the input module can also differ from the form shown in the figures. Thus, for example, the head part can have a flat surface instead of the rounded surface. In this connection it is to be noted that preferably the head part has a greater width than the base part so as to ensure a secure retention in the receiving region. However, the head part of the input module can also correspond with the width of the receiving region.

It is possible within the scope of the invention that an input module, which was removed from the fume extractor hood, is replaced merely by a single, preferably long cover. The provision of further short caps can be eliminated in this form of embodiment. However, it is also preferred to additionally provide at least one cover in the receiving region also in the case in which the input module is installed in the fume extractor hood. This cover can, for example, be used for the provision of trade mark logos. With particular preference, apart from the input module in addition two preferably short covers are provided in a receiving region, wherein the input module can be replaced each time by a long cover.

The receiving regions are preferably so designed at the fume extractor hood according to the invention that the same input module can be received in each of the receiving regions without constructional changes. The same applies to the covers which are similarly designed to be exchangeable between the different receiving regions. The form of the receiving regions, for example through provision of collars with different collar heights, can vary from receiving region to receiving region. However, it is also within the scope of the invention to design all receiving regions to be the same with respect to the fastening mechanism.

The materials used for production of the input module in the covers are preferably selected with reference to the material which was used for the housing of the fume extractor hood. The panel is thereby not immediately apparent to the observer. The covers are preferably made of a non-conductive material in order to avoid risk to the user due to mains voltage even in the case of inadvertent contact with one of the interfaces. The material for the cover can preferably be, for example, aluminium, aluminium alloys or plastic. The covers are preferably represented by extruded aluminium profile members.

As an additional safety precaution the connections to the fume extractor hood can be executed in protected low voltage. Wiring of the individual receiving regions is not restricted to the form of embodiment illustrated in FIG. 14. Conventional forms of wiring are equally usable. For example, a simple flat cable strip can be guided in the drawer, which is provided with several taps at the individual receiving regions for a plug connection. Moreover, it is also possible to design the input module with a transmitter which communicates with a receiver provided in the fume extractor hood. In this form of embodiment the input module can be fastened to, for example, the outer side of the housing of the fume extractor hood by magnetic connection and the position thereof can easily be changed.

The position of the contacts by way of which the input module can be contacted with the fume extractor hood is not restricted to the receiving regions, in particular cut-outs. It is also possible, for example, to design lines, by way of which the contacts are connected with the corresponding control apparatus in the fume extractor hood or optionally an auxiliary plate, to be of such length that the end of the line having the contact for connection with the input module can be pulled out of the fume extractor hood by way of a receiving region. In this case the control element can be used in a position outside the fume extractor hood. Moreover, it is possible to provide an extension cable at a contact fixedly provided in the receiving region, the cable in turn being able to be contacted with the input module.

Although essentially an input module for a fume extractor hood was described, the input module according to the invention can similarly be used in the described manner for other domestic appliances. Panels consisting of covers can also be used with these.

Through the fume extractor hood according to the invention and the covers according to the invention a simple and economic variant of a fume extractor hood able to be adapted in simple manner to the individual needs of the user can thus be provided. Through the different receiving regions provided in the housing of the fume extractor hood the user himself or herself or a kitchen installation specialist can in simple manner take an input module from one position to another position without having to carry out significant mounting operations. In addition, the visual appearance in the case of the fume extractor hood according to the invention remains pleasant, independently of the position of the input module, particularly through use of panels comprising covers. The fume extractor hood according to the invention additionally represents a substantial possibility of variation with respect to different brand and appliance variants. These can be premounted in simple manner during production. In particular, one or more covers can be printed with the respective trade mark logos, whereagainst the input module can be constructed to be neutral with respect to marks. The appliance variant is produced only later in the production process by the inexpensive small cover, which in a given case consists of plastics material.

1-19. (canceled)

20. A fume extractor hood, comprising:
an input module;
at least two receiving regions for selectable, detachable reception of at least a part of said input module;
at least one interface for said input module is provided at the fume extractor hood;
at least one interface is associated with each said receiving region; and
said interface represents an interface for at least one of a current supply or for signal transmission.

21. The fume extractor hood according to claim 20, including said two receiving regions are formed by cut-outs in at least a part of the housing of said fume extractor hood.

22. The fume extractor hood according to claim 20, including said interface represents at least one of an electrical contact or a receiver for at least one of infrared radiation or radio signals.

23. The fume extractor hood according to claim 20, including said fume extractor hood including at least one support plate allowing a star-shaped wiring pattern for said two receiving regions.

24. The fume extractor hood according to claim 20, including said receiving region including means for detachable connection with said input module.

25. The fume extractor hood according to claim 24, including said means for said detachable connection include at least one of detent means, screw devices or push-in strips.

26. The fume extractor hood according to claim 20, including at least one panel including at least one cover, which can be detachably received in one of said receiving regions for said input module.

27. The fume extractor hood according to claim 20, including said two covers can be received in each one of said receiving regions.

28. The fume extractor hood according to claim 27, including the dimensions of at least one cover correspond with the dimensions of said input module.

29. The fume extractor hood according to claim 26, including three covers are provided for at least one of said receiving regions, wherein the dimensions of one of said covers correspond with the dimensions of said input module.

30. The fume extractor hood to claim 20, including said fume extractor hood is formed as a flat screen hood including at least one withdrawable region and said receiving regions are provided at said withdrawable region.

31. The fume extractor hood according to claim 30, including said receiving regions are provided at least at one of the left hand side, the right hand side, the upper side or the front side of said withdrawable region.

32. An input module for an electronically controllable fume extractor hood, comprising:
at least one switching element;
the input module is formed as a unit separate from the fume extractor hood;
said input module includes at least one contact device; and
said input module can be brought into contact with at least one of several interfaces provided at said fume extractor hood, said interfaces provided for signal transmission between said input module and said fume extractor hood.

33. The input module according to claim 32, including said input module including at least one contact device for bringing said input module into contact with at least one of several interfaces provided at said fume extractor hood for current supply.

34. An input module for an electronically controllable fume extractor hood, comprising:
at least one switching element;
the input module is formed as a unit separate from the fume extractor hood;
said input module is physically spaced from said fume extractor hood; and
said input module co-operates with an interface provided at said fume extractor hood for signal transmission.

35. The input module according to claim 34, including said input module includes for co-operation with said interface a cable connected with said fume extractor hood.

36. The input module according to claim 334, including said input module includes for co-operation with said interface a transmitting device which co-operates with a receiving device provided at said fume extractor hood.

37. The input module according to claim 36, including said input module including a current supply unit.
